(19) United States
(12) Patent Application Publication
(10) Pub. No.: US 2026/0291556 A1
(43) Pub. Date: Sep. 24, 2026

(54) DYNAMIC BEAMFORMING ON SIGNALS ACQUIRED FROM A STATIC ANTENNA ARRAY

(71) Applicant: Perennial Autonomy, LLC, Menlo Park, CA (US)

(72) Inventor: Robert Stanley SMITH, JR., Cambridge, MA (US)

(21) Appl. No.: 19/575,870

(22) Filed: Mar. 23, 2026

Related U.S. Application Data
(60) Provisional application No. 63/776,892, filed on Mar. 24, 2025.

(51) Int. Cl. H04B 7/0426; H01Q 1/32; H01Q 3/26; H01Q 3/34

(52) U.S. Cl. CPC H04B 7/043; H01Q 3/2611; H01Q 3/34; H01Q 1/32

(57) ABSTRACT

Examples provide a system, method, and computer storage device for dynamic beamforming that includes a static antenna array configured to receive signals from a plurality of sources, a source identifier that analyzes the received signals to determine an amount of interest, and a weight assigner that assigns weights to the signal sources based on the determined amount of interest. A beamformer generates a beamforming pattern using the assigned weights and applies the beamforming pattern to a dynamic antenna array. The dynamic antenna array receives signals based on the applied beamforming pattern. The beamforming pattern enhances reception of prioritized signals by forming directional lobes toward sources of interest while creating nulls toward sources of little or no interest. The system optionally incorporates environmental data from sensors such as an inertial-measurement unit to account for changes in relative positions of the signal sources or the antenna arrays.

### CROSS-REFERENCE TO RELATED APPLICATION

This application claims the benefit of U.S. Provisional Patent Application Ser. No. 63/776,892 filed on Mar. 24, 2025, and entitled “Dynamic Beamforming on Signals Acquired from a Static Antenna Array,” which is hereby incorporated by reference in its entirety for all intents and purposes.

### BACKGROUND

Beamforming is a signal processing technique used in antenna arrays to achieve directional signal transmission or reception. By combining signals from multiple antenna elements such that signals at particular angles experience constructive interference and others experience destructive interference, an antenna array can achieve high directivity. Traditional static antenna arrays that lack beamforming capabilities are generally unable to achieve high directivity. Static arrays with fixed beamforming patterns lack the adaptability to respond to changing conditions such as alterations in signal source positions, antenna array positions, and environmental interferences. In dynamic environments where signal sources, receivers, or both are in motion, fixed beamforming patterns can become desynchronized from the true direction of a signal source of interest, degrading performance.

### SUMMARY

Some examples provide a dynamic beamforming system comprising a static antenna array configured to receive signals from a plurality of sources, a source identifier adapted to analyze the received signals to determine an amount of interest of the received signals, a weight assigner adapted to assign weights to the analyzed signal sources based on the determined amount of interest, a beamformer adapted to generate a beamforming pattern using the assigned weights and to apply the beamforming pattern to a dynamic antenna array, and the dynamic antenna array configured to receive signals based on the applied beamforming pattern.

Other examples provide a computerized method comprising receiving signals from a plurality of sources from a static antenna array, assigning weights to the received signals, generating a beamforming pattern based on the assigned weights to the received signals, applying the beamforming pattern to a dynamic antenna array, and receiving signals from the dynamic antenna array with the applied beamforming pattern.

Further examples provide a non-transitory computer-readable medium comprising computer-executable instructions that, when executed by a processor, cause the processor to receive signals from a plurality of sources from a static antenna array, determine an amount of interest of received signals from the static antenna array, assign weights to the received signals based on the determined amount of interest, generate a beamforming pattern based on the assigned weights to the received signals, and receive signals from a dynamic antenna array with the generated beamforming pattern.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example system of a dual-antenna array configuration for dynamic beamforming on signals acquired from a static antenna array;

FIG. 2 is a block diagram illustrating an example system of a dual-antenna array configuration for dynamic beamforming, including a navigation processor and external data connectivity;

FIG. 3 is a polar plot illustrating an example radiation pattern of a dynamic antenna array.

FIG. 4 is a flow chart illustrating an example method for dynamic beamforming on signals acquired from a static antenna array;

FIG. 5 is a flow chart illustrating another example method for dynamic beamforming on signals received from a static antenna array;

FIGS. 6A-6D are schematic diagrams illustrating example implementations of dynamic beamforming systems in spacecraft, terrestrial vehicle, high-density network, and aerial vehicle environments, respectively; and

FIG. 7 illustrates an example computing apparatus according to an example.

Corresponding reference characters indicate corresponding parts throughout the drawings. The drawings may not be to scale. Any of the figures may be combined into a single example or implementation.

### DETAILED DESCRIPTION

In contemporary telecommunication systems, the ability to efficiently manage signal reception and transmission is pivotal for ensuring high-quality communication links, especially within dynamic and multifaceted environments containing many signal sources. Traditional static antenna arrays that lack beamforming are typically incapable of achieving high directivity. This limitation presents a challenge as it hinders the efficacy of maintaining reliable communication with a signal source of interest, particularly in applications with size, space, or power constraints.

Static arrays with fixed beamforming also lack the adaptability to respond to changing conditions such as alterations in signal source positions, antenna array positions, and environmental interferences. This results in reduced performance, as the advantage of high directivity from beamforming is lessened when the signal sources move relative to the antenna array or when unexpected interferences detract from signal integrity. Fixed beamforming patterns in static antennas do not offer the flexibility needed for fine-tuned signal management in dynamic environments.

In contrast, aspects of the disclosure include an improved system with a dual antenna array configuration that combines a static and a dynamic antenna array. The static array functions primarily as a data acquisition unit to identify potential signal sources of interest, without adjustments to incoming signals. Conversely, the dynamic array leverages a programmable beamforming pattern capability, allowing it to actively manage the direction and gain of received signals. This dual framework permits a tailored approach to handling communication with signal sources of interest in dynamic environments.

The system features a static antenna array capable of receiving signals from multiple sources without modulation. The system includes hardware for identifying signals received from the static antenna array and assigning weights to the identified signals, such as based on interest. The weighted signals are used as input for a beamformer that generates a radiation or interference pattern based on the directions of the weighted signals relative to a dynamic antenna array to which the radiation pattern is applied. The applied radiation pattern enables the dynamic antenna array to increase the gain in the direction of signal sources of interest, while also decreasing the gain the direction of extraneous or unwanted signal sources, thereby improving the signal-to-noise ratio from the sources of interest and/or reducing signal interference.

Aspects of the disclosure are operable in a wide range of applications, such as extraterrestrial telecommunication, autonomous systems, high-density urban networks, and terrestrial and aerospace sectors. In an extraterrestrial telecommunication example, the dual antenna array configuration enhances telecommunication by locating signals of interest and increasing gain in the direction of the sources while accounting for movement of the dual antenna array and the signal sources. This offers better coordination and tracking of satellites in congested orbits and reduces interference from background signals from space. In an autonomous system example, the dual antenna array configuration is used to identify other vehicles to aid in autonomous navigation. This is applicable to terrestrial and aerospace examples as well. In a high-density urban network example, the system selects an area or a particular signal source among many sources, such as from a first responder, and improves the signal to noise ratio with that signal.

An example implementation includes an omni-directional dipole static antenna array that receives signals in a 360° range without additional signal modulation. The dipole static antenna array has a constant gain in outward directions and thus receives signals from all directions equally. The received signals are identified and weighted to produce a beamforming pattern. The system applies the beamforming pattern to a phased antenna array so that the phased antenna array is enabled to receive and transmit signals to signal sources of interest with increased gain. Such capability facilitates effective signal processing in the case of signal identification and focused reception/transmission with a minimal hardware footprint, thereby improving signal reception/transmission efficiency.

While described for convenience in the context of a static antenna array and a dynamic antenna array, aspects of the disclosure are operable with any quantity of static and/or dynamic antenna arrays. For example, multiple dynamic antenna arrays may be positioned facing different directions, with each direction having its own beamforming pattern. Also, each antenna array may only have a single antenna. For example, the dynamic antenna array could be a single metamaterial antenna. Further, there may only be a dynamic antenna array, and no static antenna array, where the dynamic antenna array performs the functions of the omitted static antenna array. For the purposes of this specification, the terms “antenna” and “antenna array” are used interchangeably unless explicitly stated otherwise.

In another implementation, the system described herein incorporates sensor data in the beamforming pattern computation. A sensor or combination of sensors, such as an inertial-measurement unit (IMU), measures environmental factors of the system. These measurements can include the system's acceleration, angular rate, orientation, speed, and geolocation among others. These measurements are sent as input to the beamformer to account for the movements of the system, the signal sources, or both in the computation of the beamforming pattern. Accounting for movements improves the accuracy of the applied beamforming pattern, which improves signal reception/transmission.

In another implementation, the system utilizes digital signal processing techniques to analyze key signal parameters such as amplitude, frequency, and phase. This facilitates accurate signal source identification and prioritization, improving the allocation of weights to emphasize desirable signals and create specific beamforming patterns that nullify interference from undesired directions.

In another implementation, the dynamic antenna array is a single metamaterial antenna capable of applied beamforming. The metamaterial antenna incorporates metamaterials, which have microstructures that can step-up the antenna's radiated power. A metamaterial antenna behaves as if it were much larger than its actual size, because its novel structure stores and re-radiates energy. Applying the beamforming pattern to the metamaterial antenna allows for increased directivity in size-constrained applications.

Technical solutions further involve employing adaptive algorithms that incorporate digital signal processing techniques to analyze parameters like amplitude, frequency, and phase. By using contextual data from integrated sensors, the system identifies relevant signal sources and allocates weights effectively to control beamforming patterns. This weighting allows the dynamic array to establish nulls to ignore interference and prioritize signal enhancement.

An exemplary technical effect of the system, apparatus, and method described herein is to enhance signal reception and transmission efficiency in dynamic environments with multiple signals. By integrating both a static and dynamic antenna array, the system enables adaptive signal identification, management, and optimization. In addition, frequently updating the dynamic antenna array's beamforming pattern in response to real-time data inputs from sensors like gyroscopes or accelerometers, as well as external data sources, allows the system to dynamically adapt to changing conditions. This ensures continued coverage and high communication performance in dynamic environments.

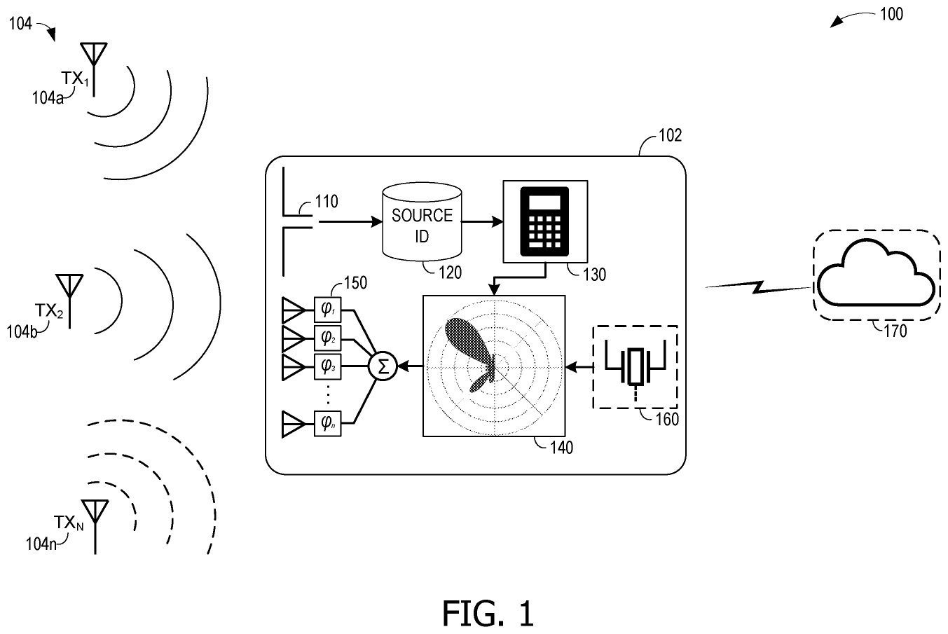

Referring to the figures, FIG. 1 illustrates an example system 100 of a dual-antenna array configuration 102 for dynamic beamforming on signals acquired from a static antenna array. The dual-antenna array configuration 102 includes a static antenna array 110, a source identifier 120, a weight assigner 130, a beamformer 140, and a dynamic antenna array 150. Optionally, the dual-antenna array configuration 102 includes a sensor 160. The dual-antenna array configuration 102 is optionally configured to communicate with an external entity 170. Components of system 100 may correspond to other components of the disclosure.

The static antenna array 110 passively receives signals from transmitter antennas 104a-n (collectively 104). The transmitters 104 emit signals represented by concentric waveforms in FIG. 1. Depending on the implementation, the static antenna array 110 receives incoming signals from multiple mobile devices or infrastructure sources, each operating at distinct frequency bands. For instance, signals are received across standard communication frequencies including 2.4 GHz and 5 GHz bands, commonly used in wireless network communications. Further depending on the implementation, each device or source emits signals at varying power strengths, such as ranging from −50 dBm to −30 dBm, as measured by the static antenna 110. These variances represent the relative power levels of the received signals, informing subsequent processing stages.

The static antenna array 110 is connected to a source identifier 120 labeled as “SOURCE ID.” The source identifier 120 analyzes signal parameters to determine an amount of interest or relevance of the received signals. In at least one embodiment, the source identifier 120 is configured to perform digital signal processing. In an example, one signal is pinpointed at 2.402 GHz with an amplitude indicative of a signal strength around −45 dBm, while another signal operates at 5.825 GHz with a strength nearing −32 dBm. Employing digital signal processing techniques, the source identifier 120 identifies these signals as originating from distinct communication devices.

In some implementations, the source identifier 120 analyzes key signal parameters such as amplitude, frequency, and phase to understand the qualities of the received signals. Amplitude refers to the strength or magnitude of the signal. Variations in amplitude can indicate the relative distance of the signal source or potential obstacles in the propagation path. By measuring these variations, the system 100 distinguishes between stronger, closer signals and weaker, more remote ones, optimizing source identification and providing a basis for evaluating signal quality and potential source distance. Frequency relates to the number of oscillations of the signal per unit time, which can help in distinguishing between different types of sources or communication channels. By performing a frequency domain analysis, the system 100 can separate signals based on their oscillation rates, aiding in the identification of individual sources within a crowded spectrum. Phase indicates the relative alignment of the waveform in time, offering insights into the timing and synchronization aspects of the signal. Phase analysis allows for determining the relative position of signals, which is particularly useful in identifying moving sources or multi-path interference scenarios.

In at least one embodiment, the source identifier 120 uses pattern recognition techniques to analyze temporal and spectral properties of the received signals. This includes evaluating the temporal and spectral properties of the signals to recognize patterns or signatures indicative of particular sources. Recurring patterns or specific modulations within the signal can be indicative of known sources or communication protocols. Identifying such patterns can enable the system 100 to assign characteristics to each source, facilitating their categorization and prioritization.

In some versions, the source identifier 120 includes a signal database. The signal database can include signal characteristics, source type, an amount of interest (e.g., a priority, level, or classification), or other identifying aspects of the stored signals. In at least one version, the source identifier 120 compares the received signals with the signals stored in the database to determine the amount of interest for assigning weights to the signal. This facilitates accurate signal source identification and prioritization.

The weight assigner 130 is implemented in a processor, such as a microcontroller unit (MCU), and is coupled to the source identifier 120, where it computes and assigns weights based on the determined amount of interest for each signal source. The weight assigner 130 then assigns weights to these identified signal sources, emphasizing sources that are important for communication processes. For instance, the system may assign a higher weight to a signal operating at 5 GHz with a −32 dBm strength due to its relevance in maintaining high-bandwidth connections for data-intensive applications.

In another example, the source identifier 120 determines a large amount of interest for the signal from transmitter 104a, a small amount of interest from transmitter 104n, and no interest from transmitter 104b. The weight assigner 130 then assigns weights to the signals from transmitters 104a, 104b, and 104n that reflect the relative amount of determined interest. The weight assigner 130 then sends the weighted signals to the beamformer 140. In other embodiments, the weight assigner sends the assigned weights to the beamformer 140 separately from the received signals.

The beamformer 140 generates a beamforming pattern based on the assigned weights of the receive signals. The beamforming pattern is a set of instructions to electronically steer the dynamic antenna array 150. This pattern enhances the reception of prioritized signals by forming directional lobes with favorable signal-to-noise ratios towards sources of interest, while creating nulls towards directions of sources with little to no interest or sources contributing to interference.

In some embodiments, the beamforming pattern controls the phase and relative amplitude of the signals received at the elements of the dynamic antenna array 150, in order to create patterns of constructive and destructive interference in the received waveforms. For example, the beamforming pattern can assign phases φ₁, φ₂, φ₃, to φₙ according to the beamforming pattern from beamformer 140 as depicted in the dynamic antenna array 150. Application of the beamforming pattern controls the orientation and gain of the received signals at the dynamic antenna array 150 to optimize signal clarity and reduce interference.

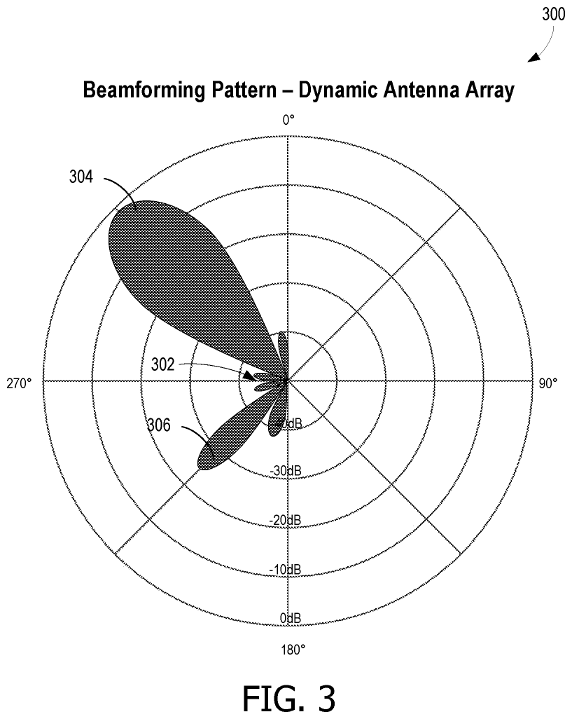

In some examples, the beamforming pattern is represented by a radiation pattern similar to the example shown in FIG. 3. In the example shown in FIG. 1, the signal source of interest from transmitter 104a is visually represented by a main lobe of the beamforming pattern within the beamformer 140 pointing towards transmitter 104a.

Optionally, the system 100 enhances signal source identification by incorporating contextual information from additional sensor(s) 160. The sensor 160 can provide data on environmental variables or motion, such as location or movement, which might influence the spatial positioning and relevance of the identified signals. This data is input into the beamformer 140, allowing the dual-antenna configuration 102 to account for changes in the relative positions of the transmitters 104 or the dynamic antenna array 150 in the beamforming pattern.

An optional external entity 170, depicted as a cloud, can provide additional context-specific information, enhancing the system's adaptability to dynamic environments and facilitating efficient signal processing. In addition, signals received at the dynamic antenna array 150 with the applied beamforming pattern can be transmitted to the external entity 170.

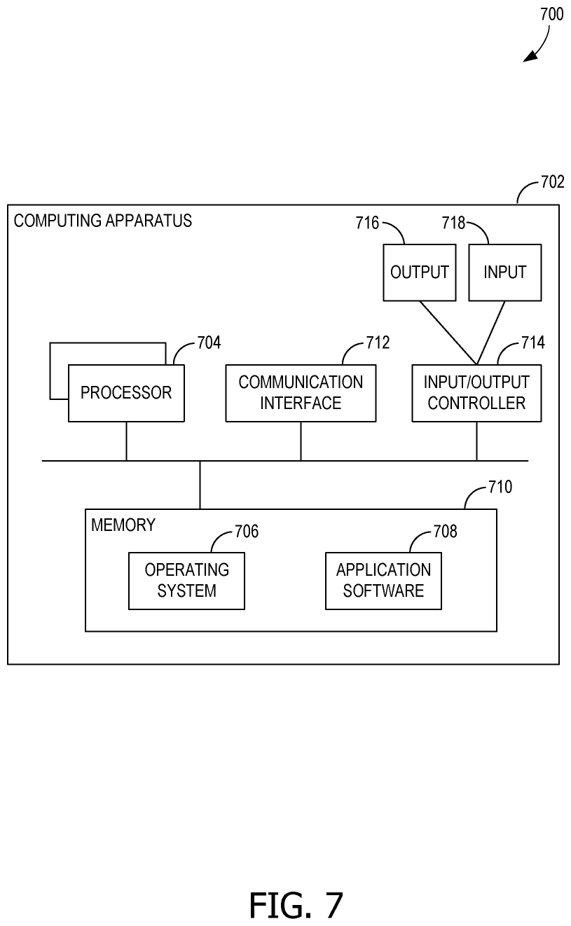

Further, in some examples, the system 100 includes one or more computing devices (e.g., the computing apparatus of FIG. 7) that are configured to communicate with each other via circuitry or one or more communication networks (e.g., an intranet, the Internet, a cellular network, other wireless network, other wired network, or the like). In some examples, entities of the system 100 are configured to be distributed between the multiple computing devices and to communicate with each other via circuitry or network connections. For example, the source identifier 120 is executed on a first computing device and the weight assigner 130 is located on a second computing device within the dual antenna configuration 102. The first computing device and second computing device are configured to communicate with each other via circuitry or network connections. Alternatively, in some examples, other components of the system 100 (e.g., beamformer 140) are executed on separate computing devices and those separate computing devices are configured to communicate with each other via network connections during the operation of the dual-antenna configuration 102. In other examples, other organizations of computing devices are used to implement system 100 without departing from the description.

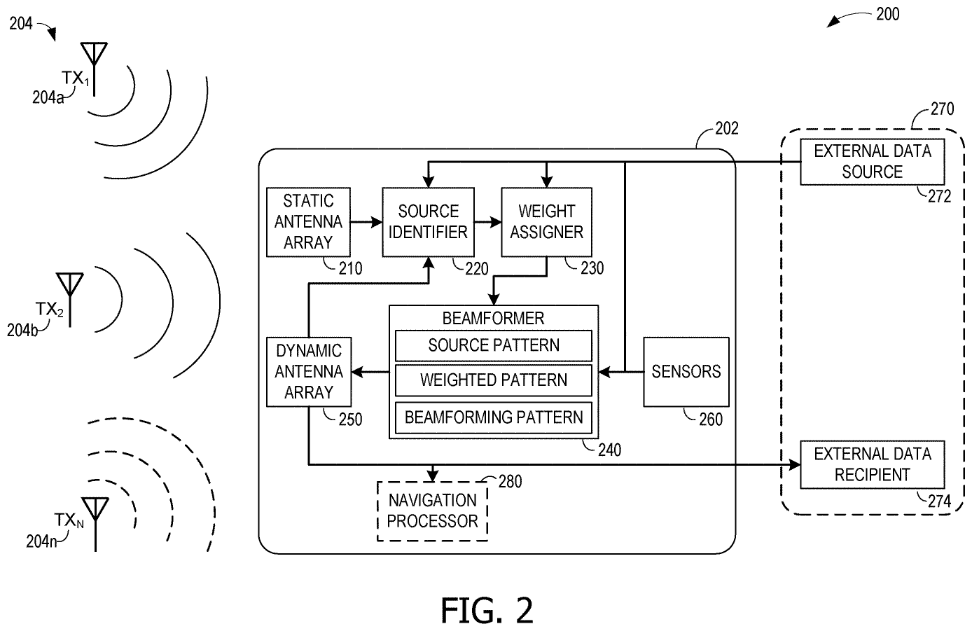

FIG. 2 illustrates another example system 200 of a dual-antenna array configuration 202 for dynamic beamforming on signals acquired from a static antenna array. The dual-antenna array configuration 202 includes a static antenna array 210, a source identifier 220, a weight assigner 230, a beamformer 240, a dynamic antenna array 250, sensors 260, an external entity 270, and a navigation processor 280. Components of system 200 may correspond to other components of the disclosure.

The static antenna array 210 receives incoming signals from various transmitters, denoted as elements 204, including specific transmitters 204a, 204b, and 204n. These signals are processed to identify their sources within a source identifier 220, which analyzes and determines an amount of interest for the signal sources. The source identifier 220 communicates with a weight assigner 230, which assigns weights to the received signal according to the determined amount of interest to facilitate effective beamforming.

The weights and the received signals are sent to the beamformer 240 as inputs. In the example shown in FIG. 2, the beamformer 140 generates a source pattern from the received signals, a weighted pattern of the assigned weights, and a beamforming pattern that is the result of the combined source and weighted patterns. The resulting beamforming pattern is then applied to the dynamic antenna array 250.

Sensors 260 may be integrated to provide additional data inputs that influence the beamforming process. The data from these sensors are used to refine the interference and beamforming patterns, allowing for adaptive adjustment based on real-time environmental conditions or positional changes.

Additionally, the system is augmented with connectivity to an external data source 272 and an external data recipient 274, which facilitate the flow of data for signal identification, weighting, and dynamic adjustments and for conveying processed signal information. In some embodiments, external data source 272 and external data recipient 274 are controlled by the same external entity 270. External data source 272 contributes additional intelligence to the dual-antenna array configuration 202, assisting the source identifier in more accurately determining the provenance and characteristics of the signal sources by cross-referencing known signal patterns or historical data.

An optional navigation processor 280 may be included to which spatial and orientation data from the dynamic antenna array 250 are provided to assist in navigating the system 200. This data from the dynamic antenna array 250 is particularly useful in autonomous systems since the transmitters 204 may be obstacles to the system 200.

In some embodiments, adaptive beamforming is implemented by continuously updating the dynamic antenna array's 250 beamforming pattern in response to environmental and motion inputs collected by external sensors 260 like gyroscopes or accelerometers, and from real-time signal reception from the dynamic antenna array 250 to the source identifier 220. This approach leverages real-time feedback to recalibrate beam directions and gains, aligning with fluctuating conditions such as environmental shifts or signal source movement, thereby optimizing signal reception and overall communication efficacy. This adaptability ensures sustained communication quality within dynamic environments, reducing interference from competing signals and optimizing overall signal clarity.

FIG. 3 is a chart 300 illustrating a graphical representation of the beamforming pattern associated with a dynamic antenna array. Aspects of chart 300 may correspond to other components of the disclosure.

Chart 300 illustrates the polar plot of a radiation pattern, highlighting the directional properties of the beamforming implemented by the dynamic antenna array. Specifically, the dynamic pattern is demonstrated with significant lobes indicating areas of enhanced signal reception or transmission and nulls where the signal is minimized.

The axis of the plot is marked with angles ranging from 0° to 360°, offering insight into the directional coverage achieved by the dynamic beamforming process. The markings in decibels (dB) illustrate the relative gain reductions at different angles, supporting the characterization of the radiation pattern formed by the dynamic antenna array.

In the example of FIG. 3, the dynamic antenna array is positioned to face leftward, and has a limited viewing angle range between 180° and 0°. The beamforming pattern of FIG. 3 has a corresponding leftward facing pattern between 180° and 0°. The angles between 0° and 180° are left blank for ease of understanding. The dynamic antenna array cannot receive signals from behind itself, so the right side of the beamforming pattern is irrelevant.

The main lobe 304 is prominently visible, extending outward from the center, denoting the primary direction of maximum gain where the signal is directed. This feature facilitates the focus on desired signal sources while minimizing interference from other directions. The presence of a side lobe 306 indicates secondary directions of signal sensitivity, albeit at reduced intensity compared to the main lobe 304.

In the example shown in FIG. 3, the main lobe 304 sets the amplitude to around −3 dB at 315°. The side lobe 306 sets the amplitude to around −25 dB at 225°. A null 302 in the beamforming pattern exists at around 270° in FIG. 3. In some versions, the null represents a signal source of no interest or a signal source causing interference. Applying a null 302 in the direction of these signal sources drastically eliminates the received signals at a dynamic antenna array, thereby eliminating noise.

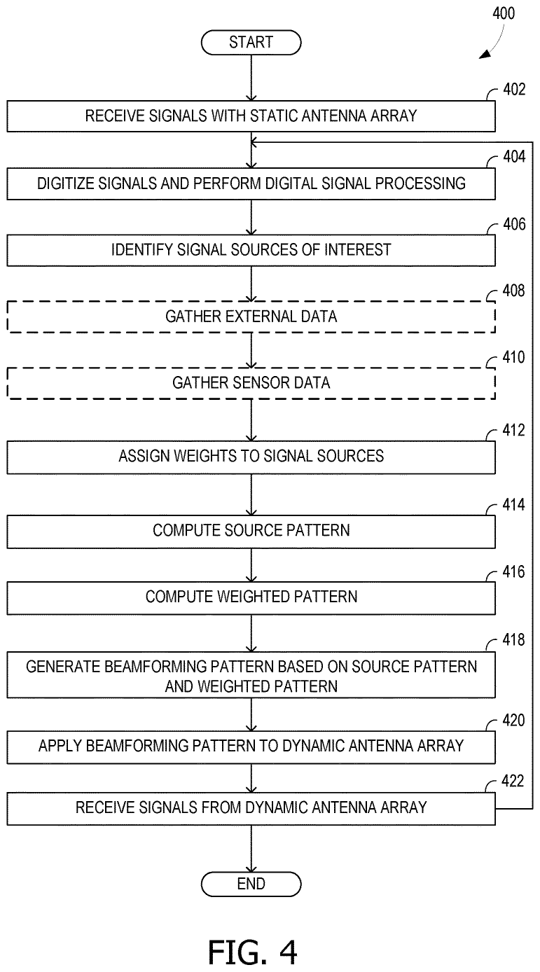

FIG. 4 shows a flowchart 400 depicting a method for dynamic beamforming on signals acquired from a static antenna array. The process initiates with receiving signals using the static antenna array, as illustrated in operation 402. This operation is followed by the digitization of signals and the execution of digital signal processing in operation 404, which prepares the signals for further analysis.

In operation 406, the method involves identifying signal sources of interest. This operation can be augmented by gathering external data 408 and sensor data 410, though these are optional operations shown in dashed lines. These data collection operations serve to provide additional context and information about the environmental conditions or specific parameters that might influence signal propagation.

Subsequently, operation 412 assigns weights to the identified signal sources, which facilitates the prioritization of certain signals. This weighting is crucial for forming a beamforming pattern that prioritizes signals of interest. operation 414 involves computing a source pattern, which establishes the baseline pattern for the signals received by the static antenna array. In operation 416, a weighted pattern is computed that reflects the assigned signal source weights. In operation 418, a beamforming pattern is generated based on the source pattern and the weighted pattern.

In operation 420, the generated beamforming pattern is applied to a dynamic antenna array. This operation enables the dynamic adjustment of the beamforming properties to accommodate variable environmental conditions and signal source movements. Finally, operation 422 completes the process by receiving signals from the dynamic antenna array, effectively optimizing signal reception and minimizing interference through adaptive beamforming techniques.

The method can iterate by returning to operation 404, but using the signals received form the dynamic antenna array instead of the static antenna array to perform adaptive beamforming. By frequently updating the dynamic array's beamforming patterns in response to real-time data inputs from sensors like gyroscopes or accelerometers, as well as environmental factors, the system dynamically adapts to changing conditions. This ensures continued coverage and high communication performance despite environmental variability.

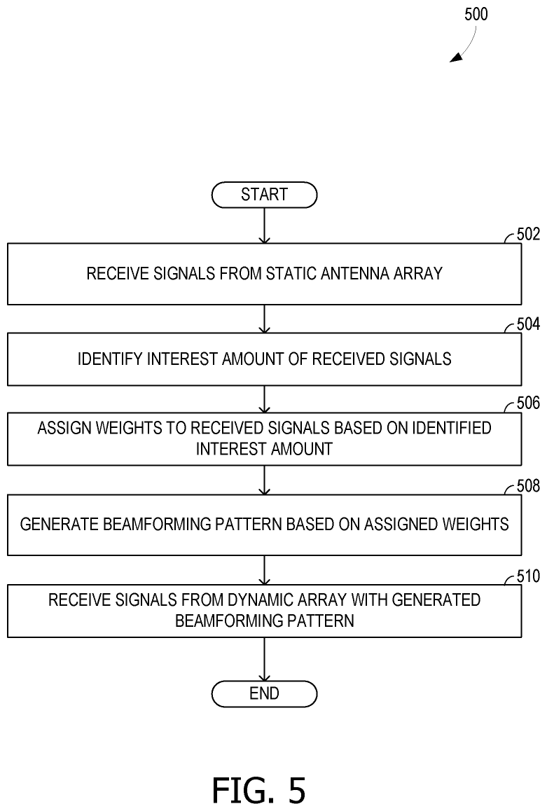

FIG. 5 is a flow chart illustrating an example process 500 for dynamic beamforming on signals obtained from a static antenna array. Process 500 involves a static antenna array and a dynamic antenna array. The operations of process 500 can be implemented using the systems and methods of the disclosure, such as systems 100 and 200 in FIGS. 1 and 2.

The process begins at a start block, leading to operation 502, where signals are received from the static antenna array. The initial signals received by the static antenna array are not modulated. Following the reception of signals, operation 504 involves identifying an interest amount of the received signals. This enables prioritization of certain signal sources and focusing on relevant signals for further analysis.

In operation 506, weights are assigned to signal sources based on the identified interest amount. This weighting process establishes a hierarchy among detected signals based on importance or relevance, facilitating the creation of a beamforming pattern optimized for specific targets. Operation 508 involves generating a beamforming pattern based on the assigned weights, allowing control over the direction and gain of the received signals of the dynamic antenna.

Finally, in operation 510, signals are received from the dynamic array with the generated beamforming pattern, optimizing reception by minimizing interference and enhancing signal quality. The process concludes at an end block, completing the method for dynamic beamforming.

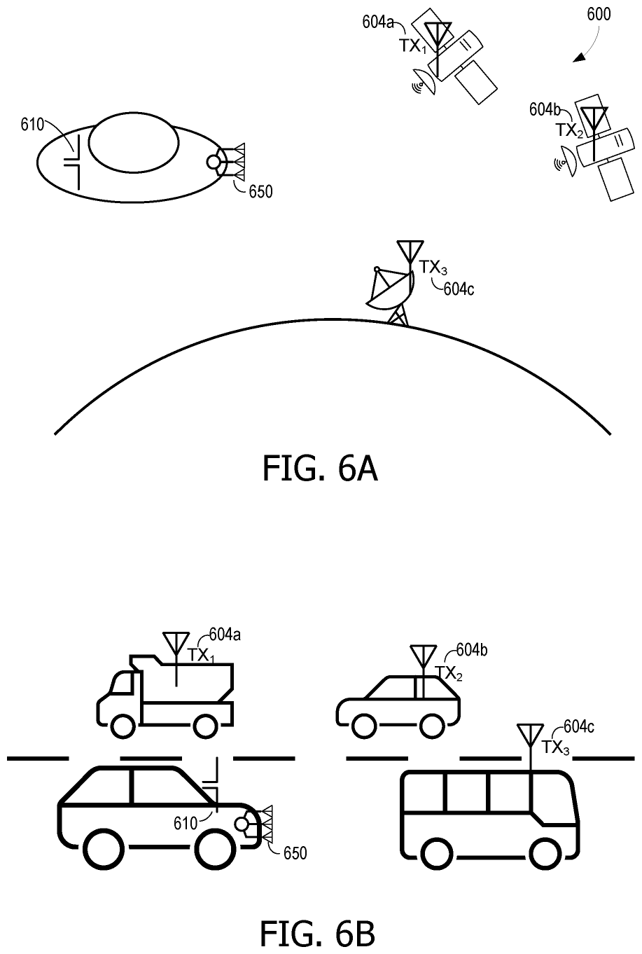

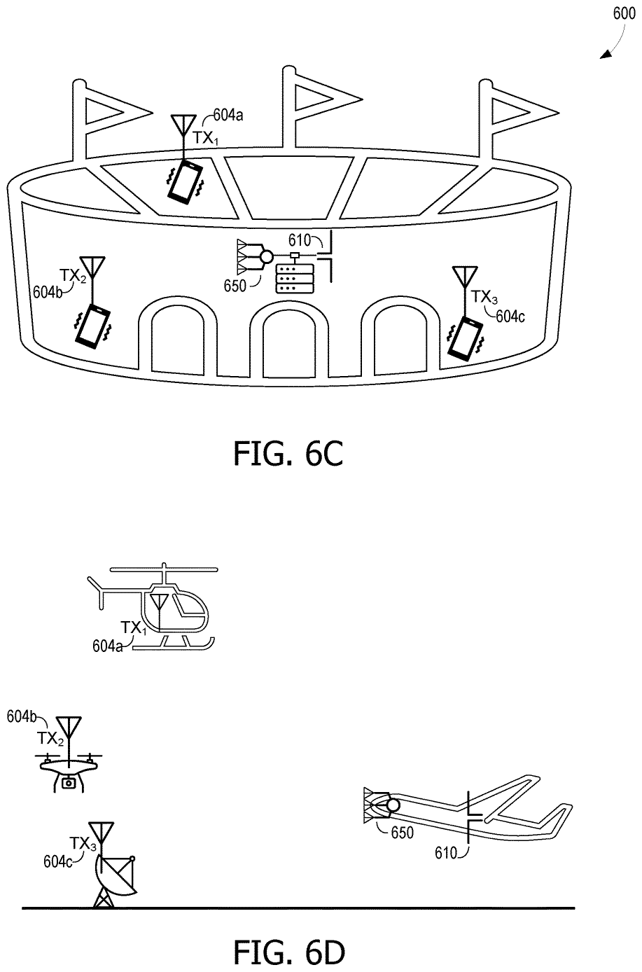

FIG. 6A-D are illustrations of example implementations of dynamic beamforming systems 600. Each dynamic beamforming system 600 includes a dual-antenna array configuration comprising a static antenna array 610 and a dynamic antenna array 650. The example dynamic beamforming systems 600 illustrate transmitter antennas 604a, 604b, and 604c to represent multiple signal sources in various environments. Dynamic beamforming systems 600 can be implemented according to the other systems and methods of the disclosure.

The dynamic beamforming systems are implemented on any platform, including mobile platforms and stationary platforms. Example of mobile platforms include, but are not limited to, uncrewed vehicles, land vehicles, uncrewed ground vehicles (UGVs), marine vehicles, surface vehicles, submersibles, uncrewed marine vehicles (UMVs), uncrewed surface and/or submersible vehicles (USVs), aircraft (e.g., fixed wing aircraft, rotorcraft, gliders, lighter-than-air craft, balloons, high-altitude balloons, uncrewed aerial vehicles (UAVs), etc.), space-based platforms, a platform carried by an individual (e.g., a backpack, etc.), and/or the like. As used herein, the dynamic beamforming system is used onboard a mobile platform while the mobile platform is moving and/or while the mobile platform is stationary. In some examples, the dynamic beamforming system is used onboard an uncrewed, autonomous mobile platform. In some examples, the dynamic beamforming system is used with a stationary platform.

The dynamic antenna array 650 aligns with these transmitters to dynamically adjust the reception patterns, accommodating positional changes of signal sources to maintain optimal communication channels.

FIG. 6A shows the dual-antenna array configuration implemented in a spacecraft. The static antenna array 610 receives signals from a first satellite with first transmitter 604a, a second satellite with second transmitter 604b, and a ground-based dish antenna 604c. The dual-antenna array configuration processes these signals and applies a beamforming pattern to the dynamic array 650. For example, the system can then choose to prioritize or exclude specific satellite signals from consideration. In another example, the system excludes any signals outside of a cone originating from the dynamic antenna array 650, such as excluding any signals not on the surface of the Earth. The dual-antenna array configuration adjusts reception patterns, accommodating positional changes of signal sources to maintain optimal communication channels.

FIG. 6B demonstrates the same concept applied in a terrestrial environment. The dual-antenna configuration is implemented into a vehicle, such as an autonomous vehicle. The static antenna array 610 receives signals from transmitters 604a, 604b, and 604c from other vehicles on the road. The dual-antenna array configuration processes these signals and applies a beamforming pattern to the dynamic array 650. In an example, the pattern can prioritize signals from other vehicles with a compatible communication system. In another example, the pattern can exclude signals from oncoming vehicles by excluding signals outside of a cone of an ahead vehicle, such as the vehicle with transmitter 604c. This configuration exemplifies how the dynamic antenna array employs real-time adaptations to maintain effective signal communication across diverse operational environments, showcasing versatility in different applications.

FIG. 6C shows the dual-antenna array configuration implemented into an internet router at a high-population density area, such as a stadium. The static antenna array 610 of the internet router receives signals from cellphones with transmitters 604a, 604b, and 604c around the area. The dual-antenna array configuration processes these signals and applies a beamforming pattern to the dynamic antenna array 650. In one example implementation, the beamforming pattern can exclude signals outside of a certain section of the area, such as a particular section in the stadium, such as the sections outside of the section with the cellphone with transmitter 604a. In another example, the dual-antenna array configuration can prioritize specific cellphones, such as cellphones of stadium staff or first responders, to ensure that these cellphones have clear lines of communication.

FIG. 6D shows the dual-antenna array configuration implemented into aerial vehicle. The static antenna array 610 of the aerial vehicle receives signals from other vehicles and antennas. In the example shown, a first transmitter 604a is onboard a helicopter, a second transmitter 604b is onboard a mobile platform, and a third transmitter 604c is on the ground. The dual-antenna array configuration processes these signals and applies a beamforming pattern to the dynamic array 650. In one example implementation, the pattern can exclude signals not from an identified ground-based transmitter 604c to reduce the likelihood of signal interference from other sources. In another example, the beamforming pattern can prioritize identified transmitters 604a and 604b onboard the other aerial vehicles to improve signal transmission/reception to those vehicles. In certain automated systems, this can notify the other aerial vehicles about the presence/flight path of the aerial vehicle, potentially enabling the vehicles to alter their own navigation to avoid a collision path.

### Exemplary Operating Environment

The present disclosure is operable with a computing apparatus according to an embodiment as a functional block diagram 700 in FIG. 7. In an example, components of a computing apparatus 702 are implemented as a part of an electronic device, such as a dynamic beamforming signal processing board for a mobile platform, according to one or more embodiments described in this specification. The computing apparatus 702 comprises one or more processors 704 which may be microprocessors, controllers, or any other suitable type of processors for processing computer executable instructions to control the operation of the electronic device. Alternatively, or in addition, the processor 704 is any technology capable of executing logic or instructions, such as a hard-coded machine. In some examples, platform software comprising an operating system 706 or any other suitable platform software is provided on the apparatus 702 to enable application software 708 to be executed on the device.

In some examples, computer executable instructions are provided using any computer-readable media that is accessible by the computing apparatus 702. Computer-readable media include, for example, computer storage media and communications media. Computer storage media, such as a memory 710, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 710) is shown within the computing apparatus 702, it will be appreciated by a person skilled in the art, that, in some examples, the storage is distributed or located remotely and accessed via a network or other communication link (e.g., using a communication interface 712).

Further, in some examples, the computing apparatus 702 comprises an input/output controller 714 configured to output information to one or more output devices 716, for example a display or a speaker, which are separate from or integral to the electronic device. Additionally, or alternatively, the input/output controller 714 is configured to receive and process an input from one or more input devices 718, for example, a keyboard, a microphone, or a touchpad. In one example, the output device 716 also acts as the input device. An example of such a device is a touch sensitive display. The input/output controller 714 may also output data to devices other than the output device, e.g., a locally connected printing device. In some examples, a user provides input to the input device(s) 718 and/or receives output from the output device(s) 716.

The functionality described herein can be performed, at least in part, by one or more hardware logic components. According to an embodiment, the computing apparatus 702 is configured by the program code when executed by the processor 704 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

An example dynamic beamforming system, comprising: a static antenna array configured to receive signals from a plurality of sources; a source identifier adapted to analyze the received signals by the static antenna array to determine an amount of interest of the received signals; a weight assigner adapted to assign weights to the analyzed signal sources based on the determined amount of interest; a beamformer adapted to generate a beamforming pattern using the assigned weights and to apply the beamforming pattern to a dynamic antenna array; and the dynamic antenna array configured to receive signals based on the applied beamforming pattern.

An example computerized method comprising: receiving signals from a plurality of sources from a static antenna array; assigning weights to the received signals; generating a beamforming pattern based on the assigned weights to the received signals; applying the beamforming pattern to a dynamic antenna array; and receiving signals from the dynamic antenna array with the applied beamforming pattern.

One or more non-transitory computer-readable media have computer-executable instructions that, upon execution by a processor, cause the processor to at least: receive signals from a plurality of sources from a static antenna array; determine an amount of interest of received signals from the static antenna array; assign weights to the received signals based on the determined amount of interest; generate a beamforming pattern based on the assigned weights to the received signals; and receive signals from a dynamic antenna array with the generated beamforming pattern.

Alternatively, or in addition to the other examples described herein, examples include any combination of the following:
a sensor adapted to capture environmental data;
a navigation processor adapted to navigate a vehicle based on signals received by the dynamic antenna array;
capturing, by a sensor, environmental data;
generating the beamforming pattern is further based on the environmental data captured by the sensor;
navigating a vehicle based on signals received by the dynamic antenna array;
determining an amount of interest of the received signals from the dynamic antenna array;
receiving signal identification data from an external entity;
wherein the beamformer is further adapted to generate the beamforming pattern using the environmental data captured by the sensor;
wherein the sensor is an inertial-measurement unit;
wherein the source identifier is further adapted to analyze the received signals from the dynamic antenna array to determine an amount of interest of the received signals from the dynamic antenna array;
wherein the source identifier is further adapted to receive signal identification data from an external entity; and
wherein the beamforming pattern includes a null in the direction of a signal source of the plurality of signal sources.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, artificial intelligence (AI) engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A dynamic beamforming system, comprising:
a static antenna array configured to receive signals from a plurality of sources;
a source identifier adapted to analyze the received signals by the static antenna array to determine an amount of interest of the received signals;
a weight assigner adapted to assign weights to the analyzed signal sources based on the determined amount of interest; and
a beamformer adapted to generate a beamforming pattern using the assigned weights and to apply the beamforming pattern to a dynamic antenna array,
wherein the dynamic antenna array is configured to receive signals based on the applied beamforming pattern.

2. The dynamic beamforming system of claim 1, further comprising:
a sensor adapted to capture environmental data,
wherein the beamformer is further adapted to generate the beamforming pattern using the environmental data captured by the sensor.

3. The dynamic beamforming system of claim 2, wherein the sensor is an inertial-measurement unit.

4. The dynamic beamforming system of claim 1, further comprising:
a navigation processor adapted to navigate a vehicle based on signals received by the dynamic antenna array.

5. The dynamic beamforming system of claim 1,
wherein the source identifier is further adapted to analyze the received signals from the dynamic antenna array to determine an amount of interest of the received signals from the dynamic antenna array.

6. The dynamic beamforming system of claim 1,
wherein the source identifier is further adapted to receive signal identification data from an external entity.

7. The dynamic beamforming system of claim 1,
wherein the beamforming pattern includes a null in the direction of a signal source of the plurality of signal sources.

8. A computerized method comprising:
receiving signals from a plurality of sources from a static antenna array;
assigning weights to the received signals;
generating a beamforming pattern based on the assigned weights to the received signals;
applying the beamforming pattern to a dynamic antenna array; and
receiving signals from the dynamic antenna array with the applied beamforming pattern.

9. The computerized method of claim 8, further comprising:
capturing, by a sensor, environmental data,
wherein generating the beamforming pattern if further based on the environmental data captured by the sensor.

10. The computerized method of claim 9,
wherein the sensor is an inertial-measurement unit.

11. The computerized method of claim 8, further comprising:
navigating a vehicle based on signals received by the dynamic antenna array.

12. The computerized method of claim 8, further comprising:
determining an amount of interest of the received signals from the dynamic antenna array.

13. The computerized method of claim 8, further comprising:
receiving signal identification data from an external entity.

14. The computerized method of claim 8,
wherein the beamforming pattern includes a null in the direction of a signal source of the plurality of signal sources.

15. A non-transitory computer-readable medium comprising computer-executable instructions that, when executed by a processor, cause the processor to perform the following operations:
receive signals from a plurality of sources from a static antenna array;
determine an amount of interest of received signals from the static antenna array;
assign weights to the received signals based on the determined amount of interest;
generate a beamforming pattern based on the assigned weights to the received signals; and
receive signals from a dynamic antenna array with the generated beamforming pattern.

16. The non-transitory computer-readable medium of claim 15, wherein the instructions further cause the processor to at least:
capture, by a sensor, environmental data,
wherein generating the beamforming pattern if further based on the environmental data captured by the sensor.

17. The non-transitory computer-readable medium of claim 16,
wherein the sensor is an inertial-measurement unit.

18. The non-transitory computer-readable medium of claim 15, wherein the instructions further cause the processor to at least:
navigate a vehicle based on signals received by the dynamic antenna array.

19. The non-transitory computer-readable medium of claim 15, wherein the instructions further cause the processor to at least:
determine an amount of interest of the received signals from the dynamic antenna array.

20. The non-transitory computer-readable medium of claim 15, wherein the beamforming pattern includes a null in the direction of a signal source of the plurality of signal sources.
